(19) United States
(12) Patent Application Publication
(10) Pub. No.: US 2016/0147444 A1
(43) Pub. Date: May 26, 2016

(54) PARALLEL DATA STORAGE IN GROUPS OF MEMORY BLOCKS HAVING SIMILAR PERFORMANCE CHARACTERISTICS

(71) Applicant: Apple Inc., Cupertino, CA (US)

(72) Inventors: Moshe Neerman, Herzlia Pituach (IL); Etai Zaltsman, Herzlia Pituach (IL); Avraham (Poza) Meir, Herzlia Pituach (IL)

(21) Appl. No.: 14/551,016

(22) Filed: Nov. 23, 2014

(51) Int. Cl. G06F 3/06

(52) U.S. Cl. CPC G06F 3/061; G06F 3/064; G06F 3/0653; G06F 3/0659; G06F 3/0679

(57) ABSTRACT

A method for data storage includes, in a memory that includes multiple memory blocks, assessing a performance characteristic of the multiple memory blocks. At least some of the memory blocks are grouped into groups using a grouping criterion that groups together the memory blocks based on similarity in the assessed performance characteristic. Data is stored in the memory by applying parallel memory access operations in the groups of the memory blocks.

### TECHNICAL FIELD

Embodiments described herein relate generally to memory devices, and particularly to methods and systems for parallel data storage.

### SUMMARY

An embodiment that is described herein provides a method for data storage including, in a memory that includes multiple memory blocks, assessing a performance characteristic of the multiple memory blocks. At least some of the memory blocks are grouped into groups using a grouping criterion that groups together the memory blocks based on similarity in the assessed performance characteristic. Data is stored in the memory by applying parallel memory access operations in the groups of the memory blocks.

In some embodiments, the grouping includes grouping at least some of the memory blocks based on similarity in memory-cell programming responsiveness. In an embodiment, the assessed performance characteristic includes at least one of programming time, erasure time, initial programming voltage, and incremental programming voltage step. In other embodiments, the grouping includes grouping at least some of the memory blocks based on similarity in memory-cell storage reliability. In an embodiment, the assessed performance characteristic includes at least one of a number of errors following programming, memory-cell voltage distribution following programming, wear level and memory-cell charge retention.

In an embodiment, grouping the memory blocks includes assigning to a given group memory blocks that differ from one another in the assessed performance characteristic by no more than a predefined difference. In another embodiment, grouping the memory blocks includes sorting the memory blocks into classes, each class including the memory blocks whose given performance characteristic falls in a respective sub-range associated with the class, and choosing the memory blocks for the given group from a single one of the classes.

In yet another embodiment, assessing the performance characteristic includes assessing the performance characteristic during production of the memory or of a host system in which the memory is to operate. In a disclosed embodiment, assessing the performance characteristic and grouping the memory blocks are performed during operation of the memory in a host system. Additionally or alternatively grouping the memory blocks includes modifying assignment of the memory blocks into the groups during operation of the memory in a host system. In an embodiment, grouping the memory blocks includes assigning the memory blocks to the given group from at least two different memory devices or storage devices.

There is additionally provided, in accordance with an embodiment that is described herein, a data storage apparatus including a memory and a processor. The memory includes multiple memory blocks. The processor is configured to group at least some of the memory blocks into groups using a grouping criterion that groups together the memory blocks based on similarity in an assessed performance characteristic, and to store data in the memory by applying parallel memory access operations in the groups of the memory blocks.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment that is described herein;

FIG. 2 is a diagram that schematically illustrates grouping of memory blocks into stripes based on programming time, in accordance with an embodiment that is described herein; and

FIG. 3 is a flow chart that schematically illustrates a method for data storage, in accordance with an embodiment that is described herein.

### DETAILED DESCRIPTION OF EMBODIMENTS

### Overview

Embodiments that are described herein provide improved methods and systems for parallel redundant data storage in non-volatile memory. In the disclosed embodiments, a processor (e.g., memory controller) stores data in multiple memory devices (e.g., Flash memory dies). In order to improve storage performance and Quality of Service (QoS), the processor applies parallel memory access operations (e.g., parallel multi-die write or read operations) in groups of memory blocks that are referred to herein as stripes, super-blocks or bands. Typically, a given stripe comprises memory blocks selected from multiple dies, and is programmed and erased en-bloc.

In many practical memory devices, memory blocks differ from one another in performance characteristics. Some performance characteristics that vary from one memory block to another have to do with programming responsiveness of the memory cells, e.g., programming (write) time (T_{PROG}), erasure time, or various Programming and Verification (P&V) parameters. Other performance characteristics have to do with memory-cell reliability or quality, such as the number of errors or the threshold-voltage distribution immediately after programming, wear level or charge retention.

Variations in such performance characteristics may be caused, for example, by production tolerances, by differences in usage among memory blocks, or for various other reasons. Unless accounted for, these differences may cause considerable degradation in performance, because the performance of a stripe is typically determined by the performance of the memory block exhibiting the poorest performance in the stripe.

In some embodiments that are described herein, the memory blocks are grouped into stripes using a grouping criterion that groups together memory blocks that are similar to one another in a given performance characteristic. Similarity in any of the performance characteristics listed above, as well as in other suitable characteristics, can be used as grouping criteria. When grouping the memory blocks in this manner, each stripe is homogenous in terms of the performance characteristic in question, even though the performance characteristic may vary considerably from one stripe to another.

As a result, high-performance memory blocks are grouped to form high-performance stripes whose performance is not held back by the presence of low-performance memory blocks. Low-performance memory blocks are grouped to form low-performance stripes, such that poor performance occurs only in a limited number of stripes. Overall, the disclosed technique increases the average performance, e.g., programming speed and throughput, of the memory system considerably.

In various embodiments, estimation of memory block performance characteristics and/or grouping of memory blocks into stripes may be performed during production and/or adaptively during normal operation.

### SYSTEM DESCRIPTION

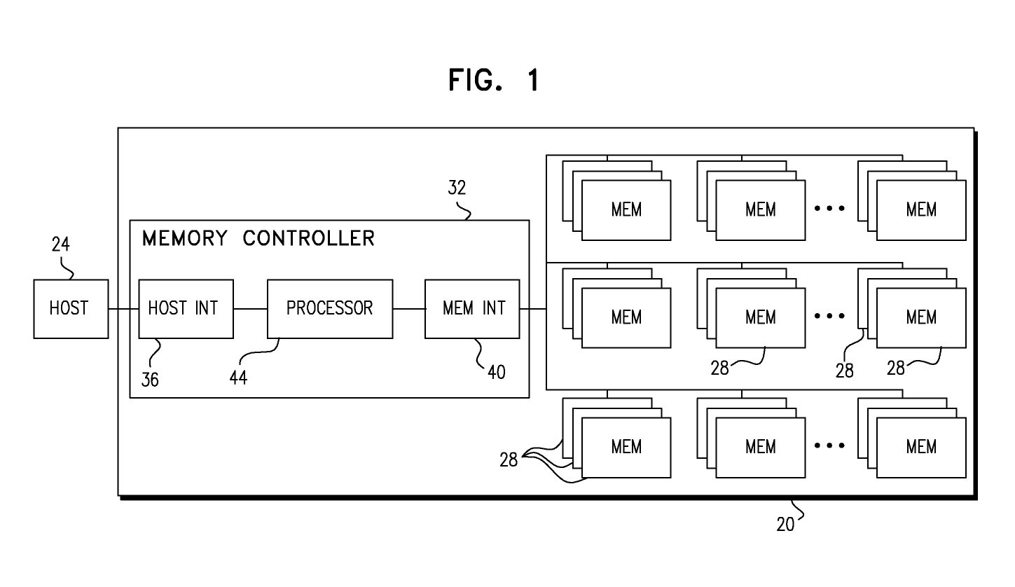

FIG. 1 is a block diagram that schematically illustrates a memory system 20, in accordance with an embodiment that is described herein. System 20 accepts data for storage from a host 24 and stores it in memory, and retrieves data from memory and provides it to the host. In the present example, system 20 comprises a Solid-State Disk (SSD) that stores data for a host computer. In alternative embodiments, however, system 20 may be used in any other suitable application and with any other suitable host, such as in computing devices, mobile phones or other communication terminals, removable memory modules such as removable memory modules, Secure Digital (SD) cards, Multi-Media Cards (MMC) and embedded MMC (eMMC), digital cameras, music and other media players and/or any other system or device in which data is stored and retrieved.

System 20 comprises multiple memory devices 28, each comprising multiple analog memory cells. In the present example, devices 28 comprise non-volatile NAND Flash devices, although any other suitable memory type, such as NOR and Charge Trap Flash (CTF) Flash cells, phase change RAM (PRAM, also referred to as Phase Change Memory—PCM), Nitride Read Only Memory (NROM), Resistive RAM (RRAM or ReRAM), Ferroelectric RAM (FRAM) and/or magnetic RAM (MRAM), or various three-dimensional memory configurations, can also be used. Although the embodiments described herein refer mainly to NVM, the disclosed techniques can also be applied in volatile memory devices.

The memory cells are typically arranged in rows and columns. Typically, a given memory device comprises multiple erasure blocks (also referred to as memory blocks), i.e., groups of memory cells that are erased together. Data typically cannot be reprogrammed in-place, and memory blocks are therefore erased before being programmed with other data.

As noted above, each memory device 28 may comprise a packaged device or an unpackaged semiconductor chip or die. A typical memory system may comprise a number of 4 GB, 8 GB or higher capacity memory devices. Generally, however, system 20 may comprise any suitable number of memory devices of any desired type and size.

System 20 comprises a memory controller 32, which accepts data from host 24 and stores it in memory devices 28, and retrieves data from the memory devices and provides it to the host. Memory controller 32 comprises a host interface 36 for communicating with host 24, a memory interface 40 for communicating with memory devices 28, and a processor 44 that processes the stored and retrieved data. The software running on processor 44 may comprise storage management software that is sometimes referred to as “Flash management” or “Flash Translation Layer” (FTL).

The functions of processor 44 can be implemented, for example, using software running on a suitable Central Processing Unit (CPU), using hardware (e.g., state machine or other logic), or using a combination of software and hardware elements.

Memory controller 32, and in particular processor 44, may be implemented in hardware. Alternatively, the memory controller may comprise a microprocessor that runs suitable software, or a combination of hardware and software elements. In some embodiments, processor 44 comprises a general-purpose processor, which is programmed in software to carry out the functions described herein. The software may be downloaded to the processor in electronic form, over a network, for example, or it may, alternatively or additionally, be provided and/or stored on tangible media, such as magnetic, optical, or electronic memory.

The system configuration of FIG. 1 is an example configuration, which is shown purely for the sake of conceptual clarity. Any other suitable memory system configuration can also be used. Elements that are not necessary for understanding the principles of the present invention, such as various interfaces, addressing circuits, timing and sequencing circuits and debugging circuits, have been omitted from the figure for clarity.

In the exemplary system configuration shown in FIG. 1, memory devices 28 and memory controller 32 are implemented as separate Integrated Circuits (ICs). In alternative embodiments, however, the memory devices and the memory controller may be integrated on separate semiconductor dice in a single Multi-Chip Package (MCP) or System on Chip (SoC), and may be interconnected by an internal bus. Further alternatively, some or all of the memory controller circuitry may reside on the same die on which one or more of the memory devices are disposed. Further alternatively, some or all of the functionality of memory controller 32 can be implemented in software and carried out by a processor or other element of the host system, or by any other type of memory controller. In some embodiments, host 24 and Memory controller 32 may be fabricated on the same die, or on separate dice in the same device package.

### Grouping of Memory Blocks into Stripes Based on Performance Similarity

In some embodiments, processor 44 of memory controller 32 stores data in memory devices 28 using parallel memory access operations. Examples of parallel memory access operations include multi-die write commands that write multiple pages into multiple respective dies in parallel, and multi-die write commands that read multiple pages from multiple respective dies in parallel.

Typically, the memory blocks are grouped into groups, with each group comprising memory blocks selected from multiple memory devices, and processor 44 performs the parallel memory access operations within each of the groups. The groups are also referred to as stripes or bands, and the description that follows refers mainly to stripes.

A given stripe is typically written en-bloc. In other words, a data write or read operation is typically performed in multiple memory blocks in the appropriate stripe. Therefore, as explained above, the programming/readout performance of a given stripe is determined by the memory block having the poorest performance in the stripe. Variations in programming time, for example, may vary from one block to another by −10% or more.

Thus, in some embodiments the memory blocks in system 20 are assigned to stripes such that all the memory blocks in a given stripe are similar to one another in a given performance characteristic. In other words, the memory blocks are assigned to stripes using a grouping criterion that groups together memory blocks that are similar to one another in a given performance characteristic.

The grouping criterion may consider similarities in any suitable performance characteristic, and/or combination of two or more performance characteristics. Non-limiting examples of performance characteristics that vary from one memory block to another include programming (write) time (T_{PROG}), erasure time, Programming and Verification (P&V) parameters such as initial programming voltage or incremental programming-voltage step, the number of errors immediately after programming, the threshold-voltage distribution immediately after programming, wear level, charge retention, or any other suitable characteristic.

The description that follows focuses on grouping by similarity in programming time (T_{PROG}). This choice, however, is made purely for the sake of conceptual clarity. In alternative embodiments, the disclosed techniques are similarly applicable to any other suitable performance characteristic.

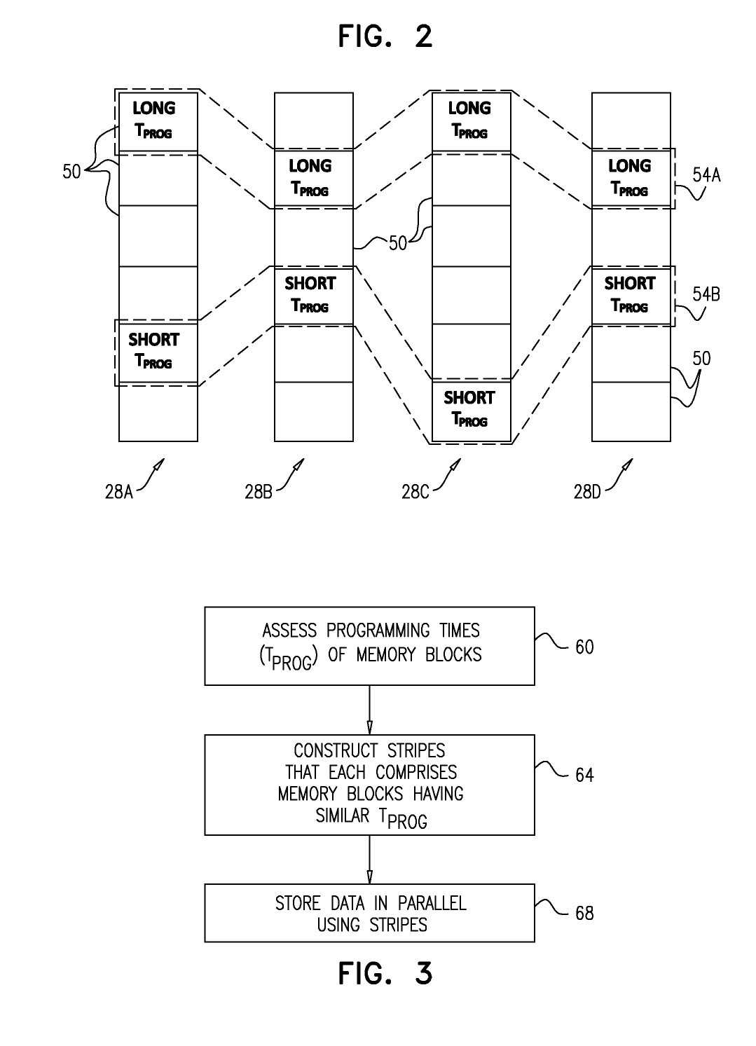

FIG. 2 is a diagram that schematically illustrates grouping of memory blocks into stripes based on programming time, in accordance with an embodiment that is described herein. The present example shows four dies denoted 28A . . . 28D although additional dies may be present in other examples, each comprising multiple memory blocks 50. Two example stripes 54A and 54B are shown in the figure, although additional stripes may be present in other examples. Each stripe comprises four memory blocks—a respective block from each die. Stripe 54A is formed from memory blocks having long T_{PROG}, whereas stripe 54B is formed from memory blocks having short T_{PROG}.

This sort of grouping prevents slow memory blocks from unnecessarily slowing down entire stripes. In the disclosed embodiments, slow memory blocks are concentrated in a small number of stripes, and the remaining stripes are able to achieve high programming speed.

As can be seen in the figure, the assignment of memory blocks to stripes is not fixed to the physical locations or indices of the blocks in the die. This property may cause slight complication in management, but the added complexity is typically outweighed by the improvement in programming speed.

The configuration of FIG. 2 is given purely by way of example. In alternative embodiments, the disclosed techniques can be used with any other suitable number of dies, stripe size and grouping criterion.

In some embodiments, estimation of T_{PROG} for the various memory blocks is performed during production of the memory dies or of system 20. Additionally or alternatively, estimation of T_{PROG} may be performed adaptively by processor 44 during operation of system 20. Grouping of memory blocks into stripes may also be performed during production and/or adaptively by processor 44 during operation. As a result, processor 44 is able to modify the grouping of memory blocks into stripes in response to changes in T_{PROG} that occur along the lifetime of the memory dies.

The memory blocks may be grouped into stripes using various similarity criteria. In one embodiment, each stripe is formed from memory blocks whose programming times differ by no more than a predefined difference. In another embodiment, the memory blocks are pre-sorted into classes, referred to as bins. Each class or bin contains the memory blocks whose T_{PROG} falls in a respective sub-range of T_{PROG} values. Grouping is performed by choosing the memory blocks for a given stripe from a single bin.

Any suitable number of bins can be used. The bin size (i.e., the difference between the highest and lower T_{PROG}) is not necessarily equal in all the bins. For example, one bin may comprise the 10% memory blocks having the slowest T_{PROG}, and a second bin may comprise all other memory blocks. Further alternatively, system 20 may use any other suitable T_{PROG} similarity criterion for grouping memory blocks into stripes.

FIG. 3 is a flow chart that schematically illustrates a method for data storage, in accordance with an embodiment that is described herein. The method begins by assessing the programming times of respective memory blocks in memory devices 28, at an estimation step 60. At a grouping step 64, the memory blocks are grouped into stripes, such that the memory blocks of each stripe have similar programming times. At a storage step 68, processor 44 of memory controller 32 stores data in memory devices 28 by applying parallel memory access operations within each stripe.

Although the embodiments described herein mainly address data storage in multiple Flash dies operated in parallel, the methods and systems described herein can also be used in other applications, such as in multiple storage devices such as hard drives organized in stripes with or without redundancy.

It will thus be appreciated that the embodiments described above are cited by way of example, and that the following claims are not limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for data storage, comprising:
in a memory that comprises multiple memory blocks, assessing a performance characteristic of the multiple memory blocks;
grouping at least some of the memory blocks into groups using a grouping criterion that groups together the memory blocks based on similarity in the assessed performance characteristic; and
storing data in the memory by applying parallel memory access operations in the groups of the memory blocks.

2. The method according to claim 1, wherein the grouping comprises grouping at least some of the memory blocks based on similarity in memory-cell programming responsiveness.

3. The method according to claim 2, wherein the assessed performance characteristic comprises at least one of programming time, erasure time, initial programming voltage, and incremental programming voltage step.

4. The method according to claim 1, wherein the grouping comprises grouping at least some of the memory blocks based on similarity in memory-cell storage reliability.

5. The method according to claim 4, wherein the assessed performance characteristic comprises at least one of a number of errors following programming, memory-cell voltage distribution following programming, wear level and memory-cell charge retention.

6. The method according to claim 1, wherein grouping the memory blocks comprises assigning to a given group memory blocks that differ from one another in the assessed performance characteristic by no more than a predefined difference.

7. The method according to claim 1, wherein grouping the memory blocks comprises sorting the memory blocks into classes, each class comprising the memory blocks whose given performance characteristic falls in a respective sub-range associated with the class, and choosing the memory blocks for the given group from a single one of the classes.

8. The method according to claim 1, wherein assessing the performance characteristic comprises assessing the performance characteristic during production of the memory or of a host system in which the memory is to operate.

9. The method according to claim 1, wherein assessing the performance characteristic and grouping the memory blocks are performed during operation of the memory in a host system.

10. The method according to claim 1, wherein grouping the memory blocks comprises modifying assignment of the memory blocks into the groups during operation of the memory in a host system.

11. The method according to claim 1, wherein grouping the memory blocks comprises assigning the memory blocks to the given group from at least two different memory devices or storage devices.

12. A data storage apparatus, comprising:
a memory comprising multiple memory blocks; and
a processor, which is configured to group at least some of the memory blocks into groups using a grouping criterion that groups together the memory blocks based on similarity in an assessed performance characteristic, and to store data in the memory by applying parallel memory access operations in the groups of the memory blocks.

13. The apparatus according to claim 12, wherein the processor groups the memory blocks based on similarity in memory-cell programming responsiveness.

14. The apparatus according to claim 12, wherein the processor groups the memory blocks based on similarity in memory-cell storage reliability.

15. The apparatus according to claim 12, wherein the processor is configured to assign to the given group of memory blocks that differ from one another in the assessed performance characteristic by no more than a predefined difference.

16. The apparatus according to claim 12, wherein the memory blocks are sorted into classes, each class comprising the memory blocks whose assessed performance characteristic falls in a respective sub-range associated with the class, and wherein the processor is configured to choose the memory blocks for the given group from a single one of the classes.

17. The apparatus according to claim 12, wherein assessment of the performance characteristic is performed during production of the memory or of a host system in which the memory is to operate.

18. The apparatus according to claim 12, wherein the processor is configured to assess the performance characteristic and group the memory blocks during operation of the memory in a host system.

19. The apparatus according to claim 12, wherein the processor is configured to modify assignment of the memory blocks into the groups during operation of the memory in a host system.

20. The apparatus according to claim 12, wherein the processor is configured to assign the memory blocks to the given group from at least two different memory devices or storage devices.
